(19) United States
(12) Patent Application Publication
(10) Pub. No.: US 2020/0378556 A1
(43) Pub. Date: Dec. 3, 2020

(54) CRYOGENIC STORAGE SYSTEM WITH IMPROVED TEMPERATURE STABILITY

(71) Applicant: 21st Century Medicine, Inc, Fontana, CA (US)

(72) Inventors: Brian WOWK, Fontana, CA (US); Lirrsdo CHOW, Fontana, CA (US); J. Dean BARRY, Fontarta, CA (US)

(21) Appl. No.: 16/496,642

(22) PCT Filed: Oct. 26, 2017
(86) PCT No.: PCT/US2017/058580

§ 371 Date: Sep. 23, 2019

(51) Int. Cl. F17C 1/12; F17C 5/04; F17C 13/04

(52) U.S. Cl. CPC F17C 1/12; F17C 5/04; F17C 13/04; F17C 2223/0161; F17C 2270/0509; F17C 2221/014; F17C 2205/0352; F17C 2205/0326; F17C 2203/0391; F17C 2201/0166; F17C 2201/032; F17C 2203/0308; F17C 2203/0629; F17C 2227/0353

(57) ABSTRACT

The present disclosure relates to devices and methods for the storage of material at cryogenic temperatures. Such devices may be useful for storing materials in the vapor space of a cryogenic dewar at a stable temperature and for preventing temperature excursions that may otherwise occur during refilling of a dewar with liquid cryogen. In some implementations, the devices may include a cryogen space holding liquid cryogen and gas, a separate storage space containing only gas, and a separate path for gas to leave the cryogen space during cryogen refills without passing through or substantially disturbing the temperature of the storage space. Some implementations further provide for passage of gas from the cryogen space to the storage space between cryogen refills to improve cryogen utilization efficiency.

### TECHNICAL FIELD

The present disclosure relates to the field of cryogenic storage systems.

### BACKGROUND

The following discussion is merely provided to aid the reader in understanding and is not admitted to describe or constitute prior art. The discussion uses liquid nitrogen as an example, but systems and methods of the present disclosure are not limited to liquid nitrogen. The same considerations may apply to storage systems utilizing other cryogens.

Vacuum dewars holding liquid nitrogen are widely used for storage of cryopreserved biological materials. The cryopreserved materials may be stored under the liquid nitrogen or in the cold vapor space above the liquid nitrogen.

Storage of material in the cold vapor space of a dewar, sometimes called vapor-phase storage, has both advantages and disadvantages. It is advantageous because it avoids transmission of contaminants or infectious agents between samples stored in a common pool of liquid nitrogen. Vapor-phase storage is disadvantageous because, unlike the constant temperature of boiling liquid nitrogen, the temperature of the vapor space above liquid nitrogen is generally variable.

The temperature of the vapor space of a dewar generally increases with height above the surface of the liquid nitrogen. The temperature gradient that exists above the liquid nitrogen can be reduced to create a vapor space of more uniform temperature by adding a thermally-conductive sleeve to the inner wall of the dewar. A storage space of more uniform temperature can also be created by placing one or more temperature chambers comprising an insulated container with a thermally-conductive inner wall into the vapor space of the dewar.

The temperature of the vapor space of a dewar is often disturbed when the dewar is refilled with liquid nitrogen. During refilling, liquid nitrogen from pressurized sources boils due to release of pressure and contact with warmer surfaces. Liquid nitrogen also boils as it travels through pipes and hoses that carry liquid nitrogen from supply tanks to the dewar. The boiling forms gas bubbles in the liquid nitrogen. This gas mixed with liquid nitrogen is about as cold as liquid nitrogen itself. Long lines connecting supply tanks at centralized locations are especially vulnerable to filling with large quantities of gas mixed with the liquid nitrogen. When the mixture of liquid nitrogen and gas enters a dewar of the prior art, e.g., as shown in the example of FIG. 1, the cold gas generally may only leave through openings 16 between the dewar lid and the top of the dewar. To do so, the cold gas must first rise through the interior space of the dewar where materials are stored. This typically causes the temperature of the vapor space of the dewar to drop during refilling of the liquid nitrogen.

Some refilling systems reduce the amount of gas mixed with liquid nitrogen during filling with “Hot Gas Bypass” systems. These systems generally divert flowing gas and liquid nitrogen from the supply pipes and hoses to the environment outside the dewar for a period of time after the start of filling, allowing the pipes and hoses carrying the liquid nitrogen to cool before the flow is allowed to enter the dewar. However the primary purpose of these systems is to prevent warm gas that precedes the liquid nitrogen flow from entering the dewar. Once substantial quantities of liquid nitrogen begin to flow, the gas mixed with the liquid nitrogen will have the same temperature as the liquid nitrogen and the Hot Gas Bypass will cease to operate. Both the liquid nitrogen and cold gas mixed with it will be allowed to enter the dewar. Depending on the supply pressure and heat leak into the supply pipes and hoses, some quantity of cold gas will remain mixed with the liquid nitrogen entering the dewar during the entire time period of refilling. This cold gas usually disturbs the temperature of stored materials inside the dewar by convention and conduction as it passes through the vapor space to leave through the top of the dewar.

One solution to mitigate the effect of vapor temperature excursions during dewar refilling is to thermally insulate stored materials inside a “temperature chamber” situated in the dewar vapor space and to provide electric heat as needed to counteract cooling of the vapor space during dewar refilling. However, insulation generally only reduces the magnitude of temperature changes rather than eliminating them. Furthermore, feedback control necessitates that some measurable temperature disturbance occur inside insulated storage spaces before heaters can compensate.

### SUMMARY

A need therefore exists for a cryogenic dewar that permits liquid nitrogen to be refilled without the cold gas that emerges from the liquid nitrogen disturbing the temperature of materials stored inside the dewar. However, between refilling and during steady-state operation of the dewar, it may be advantageous to allow cold gas that emerges from boiling liquid nitrogen to make thermal contact with stored materials. By allowing such contact, and allowing cold gas produced by evaporation of liquid nitrogen between refills to exit out the top of the dewar, the cooling power of liquid nitrogen may be more efficiently utilized. Such efficiency reduces consumption of liquid nitrogen. Therefore, a need also exists for a dewar that admits gas from boiling liquid nitrogen into a dewar storage space between refills, while excluding it during refills.

Embodiments of the present disclosure relate to devices for storing materials at a cryogenic temperature. Devices of the present disclosure may enable the user to store materials for long periods of time in a vapor storage space with minimal temperature disturbance during refilling of the cryogen that maintains the cryogenic temperature. Embodiments are also provided that permit cold vapor generated by cryogen boiling between refills to assist with maintenance of the desired cold temperature of the storage space.

As used herein, a “dewar” is defined as a container configured for maintaining cryogenic temperatures within it, comprising an inner and outer wall with high vacuum thermal insulation between the walls. High vacuum thermal insulation is defined as a space evacuated to a pressure of less than 0.1 torr to inhibit conductive and convective heat transfer, possibly with additional provisions to inhibit radiative heat transfer.

As used herein, “cryogenic temperature” is defined as any temperature below −20° C.

As used herein, a “cryogen” is defined as the liquid state of an element or compound with a boiling point below −20° C. when at an ambient pressure of one standard atmosphere (760 mmHg). Non-limiting examples of cryogens include nitrogen, helium, argon, neon, oxygen, hydrogen, or the like.

As used herein, a “conduit” is defined as any channel for conveying a fluid, such as a pipe, hose, tube, or the like. A conduit may be formed of any plastic, such as polyvinyl chloride (PVC) or the like, or any metal, such as steel or the like. In some embodiments, the conduits may be insulating to inhibit heat transfer between the fluid and an environment surrounding the conduit.

As used herein, “walls” refer to any structures that enclose a space or volume. Walls of a dewar may be formed of metal, such as steel or the like, or of silvered glass.

As used herein, “barrier” refers to any structure that is impermeable to gas or liquid. A barrier in a dewar may be formed of metal, such as steel, or any other solid material that is impermeable to gas or liquid.

The following is a non-limiting list of embodiments of the present disclosure:

Embodiment 1. A device for storing material at a cryogenic temperature, comprising:
a dewar having inner walls and outer walls;
a storage space within the dewar configured to store materials;
a cryogen space within the dewar containing liquid cryogen and cryogen gas;
a barrier between the storage space and cryogen space permitting substantially no exchange of gas or liquid between them;
one or more first conduits configured to carry liquid cryogen from the external environment outside the dewar to fill the cryogen space without penetrating the storage space or releasing cryogen into the storage space; and
one or more second conduits configured to carry gas from the cryogen space to the external environment outside the dewar without penetrating the storage space or releasing gas into the storage space.

Embodiment 2. A device for storing material at a cryogenic temperature, comprising:
a dewar having inner walls and outer walls;
a storage space within the dewar configured to store materials;
a cryogen space within the dewar containing liquid cryogen and cryogen gas;
a barrier between the storage space and cryogen space permitting substantially no exchange of gas or liquid between them;
one or more first conduits configured to carry liquid cryogen from the external environment outside the dewar to fill the cryogen space without penetrating the storage space or releasing cryogen into the storage space; and
one or more second conduits configured to carry gas from the cryogen space to either the storage space or the external environment outside the dewar, or both, with one or more valves configured to switch between sending gas from the cryogen space to the storage space and sending gas from the cryogen space to the external environment outside the dewar.

Embodiment 3. The device of embodiment 2, wherein the one or more valves include a three-port valve configured to switch between directing gas from the cryogen space entering a common port of the three-port valve to the storage space and directing gas from the cryogen space entering the common port to the external environment outside the dewar.

Embodiment 4. The device of embodiment 2, wherein the one or more valves comprise a plurality of valves, and the plurality of valves are configured to be synchronized such that gas from the cryogen space flows to either the cryogen space or the external environment without simultaneously flowing to both or neither.

Embodiment 5. The device of embodiment 2, wherein:
each second conduit carrying gas from the cryogen space is bifurcated into two conduit branches, a first conduit branch leading to the storage space, and a second conduit branch leading to the external environment outside the dewar;
wherein the one or more valves include a valve connected to the second conduit branch configured to, when open, direct gas from the cryogen space to leave the dewar and, when closed, direct gas from the cryogen space to the storage space; and
wherein a flow resistance of the first conduit branch differs from a flow resistance of the second conduit branch such that, when the valve connected to the second conduit branch is open, more gas leaving the cryogen space flows through the second branch than the first branch.

Embodiment 6. The device of embodiment 5, wherein the first conduit branch has an adjustable gas flow resistance.

Embodiment 7. The device of embodiment 2, wherein second conduits leading to the storage space have a higher flow resistance than second conduits leading to the external environment such that, when the latter conduits are open, more gas from the cryogen space flows to the external environment outside the dewar than to the storage space.

Embodiment 8. The device of embodiment 7, wherein the second conduits leading to the storage space have an adjustable gas flow resistance.

Embodiment 9. The device of embodiment 2, wherein the one or more valves are located outside the dewar.

Embodiment 10. The device of embodiment 9, wherein the one or more valves comprise relief valves configured to open automatically when pressure inside the cryogen space rises.

Embodiment 11. The device of embodiments 1 or 2, wherein the first conduits and the second conduits are substantially contained within a vacuum space between the inner and the outer walls.

Embodiment 12. The device of embodiment 11, wherein the first conduits and the second conduits include insulation.

Embodiment 13. The device of embodiment 2, wherein a default state of the one or more valves directs gas from the cryogen space into the storage space, and a power-on state of the one or more valves directs gas from the cryogen space to the external environment.

Embodiment 14. The device of embodiment 13, wherein the one or more valves are configured to be in the power-on state during cryogen refilling.

Embodiment 15. A method of reducing temperature disturbance within a storage space of a dewar during refilling of liquid cryogen, comprising:
adjusting the one or more valves to direct gas to the external environment of the dewar during refilling; and
adjusting the one or more valves to direct gas to the storage space of the dewar before and after refilling,
wherein the dewar comprises the dewar of embodiments 2 to 10, 13, or 14.

Embodiment 16. A method of reducing temperature disturbance within a storage space of a dewar during refilling of liquid cryogen, comprising:
adjusting the one or more valves to direct gas to the external environment of the dewar during refilling; and
adjusting the one or more valves to direct gas to the storage space of the dewar before and after refilling,
wherein the dewar comprises the dewar of embodiment 11.

Embodiment 17. A method of reducing temperature disturbance within a storage space of a dewar during refilling of liquid cryogen, comprising:
adjusting the one or more valves to direct gas to the external environment of the dewar during refilling; and
adjusting the one or more valves to direct gas to the storage space of the dewar before and after refilling,
wherein the dewar comprises the dewar of embodiment 12.

Embodiment 18. A method of reducing entry of warm, moist air into the storage space of a dewar during opening of a dewar lid, the method comprising:
opening at least one of the one or more valves; and
injecting dry gas into at least one of the second conduits such that the dry gas flows into the cryogen space and then into the storage space,
wherein the dewar comprises the dewar of embodiments 2 to 10, 13, or 14.

Embodiment 19. A method of reducing entry of warm, moist air into the storage space of a dewar during opening of a dewar lid, the method comprising:
opening at least one of the one or more valves; and
injecting dry gas into at least one of the second conduits such that the dry gas flows into the cryogen space and then into the storage space,
wherein the dewar comprises the dewar of embodiment 11.

Embodiment 20. A method of reducing entry of warm, moist air into the storage space of a dewar during opening of a dewar lid, the method comprising:
opening at least one of the one or more valves; and
injecting dry gas into at least one of the second conduits such that the dry gas flows into the cryogen space and then into the storage space,
wherein the dewar comprises the dewar of embodiment 12.

Embodiment 21. A method of reducing entry of warm, moist air into the storage space of a dewar during opening of a dewar lid, the method comprising:
injecting dry gas into at least one of the first conduits such that the dry gas bubbles through the liquid cryogen and flows from the cryogen space to the storage space,
wherein the dewar comprises the dewar of embodiments 2 to 10, 13, or 14.

Embodiment 22. A method of reducing entry of warm, moist air into the storage space of a dewar during opening of a dewar lid, the method comprising:
injecting dry gas into at least one of the first conduits such that the dry gas bubbles through the liquid cryogen and flows from the cryogen space to the storage space,
wherein the dewar comprises the dewar of embodiment 11.

Embodiment 23. A method of reducing entry of warm, moist air into the storage space of a dewar during opening of a dewar lid, the method comprising:
injecting dry gas into at least one of the first conduits such that the dry gas bubbles through the liquid cryogen and flows from the cryogen space to the storage space,
wherein the dewar comprises the dewar of embodiment 12.

Embodiment 24. A method of accelerating cooling of the storage space of a dewar, the method comprising:
injecting dry gas into at least one of the first conduits such that the dry gas bubbles through the liquid cryogen and flows from the cryogen space to the storage space,
wherein the dewar comprises the dewar of embodiments 2 to 10, 13, or 14.

Embodiment 25. A method of accelerating cooling of the storage space of a dewar, the method comprising:
injecting dry gas into at least one of the first conduits such that the dry gas bubbles through the liquid cryogen and flows from the cryogen space to the storage space,
wherein the dewar comprises the dewar of embodiment 11.

Embodiment 26. A method of accelerating cooling of the storage space of a dewar, the method comprising:
injecting dry gas into at least one of the first conduits such that the dry gas bubbles through the liquid cryogen and flows from the cryogen space to the storage space,
wherein the dewar comprises the dewar of embodiment 12.

Embodiment 27. Apparatus for storing material at a cryogenic temperature, comprising:
a dewar having inner walls and outer walls;
a storage space within the dewar adapted to store materials;
a cryogen space within the dewar containing liquid cryogen and cryogen gas;
a barrier between the storage space and cryogen space permitting substantially no exchange of gas or liquid between them; and
one or more first conduits adapted to carry liquid cryogen from the external environment outside the dewar to fill the cryogen space without penetrating the storage space or releasing cryogen into the storage space,
characterized in that
the apparatus further comprises one or more second conduits adapted to carry gas from the cryogen space to the external environment outside the dewar without penetrating the storage space or releasing gas into the storage space.

Embodiment 28. Apparatus for storing material at a cryogenic temperature, comprising:
a dewar having inner walls and outer walls;
a storage space within the dewar adapted to store materials;
a cryogen space within the dewar containing liquid cryogen and cryogen gas;
a barrier between the storage space and cryogen space permitting substantially no exchange of gas or liquid between them; and
one or more first conduits adapted to carry liquid cryogen from the external environment outside the dewar to fill the cryogen space without penetrating the storage space or releasing cryogen into the storage space,
characterized in that
the apparatus further comprises one or more second conduits adapted to carry gas from the cryogen space to either the storage space or the external environment outside the dewar, or both, with one or more valves configured to switch between sending gas from the cryogen space to the storage space and sending gas from the cryogen space to the external environment outside the dewar.

Embodiment 29. Apparatus according to embodiment 28, further characterized in that the one or more valves include a three-port valve adapted to switch between directing gas from the cryogen space entering a common port of the three-port valve to the storage space and directing gas from the cryogen space entering the common port to the external environment outside the dewar.

Embodiment 30. Apparatus according to embodiment 28, further characterized in that
the one or more valves comprise a plurality of valves, and
the apparatus further comprises means for synchronizing the plurality of valves so that gas from the cryogen space flows to either the cryogen space or the external environment without simultaneously flowing to both or neither.

Embodiment 31. Apparatus according to embodiment 28, further characterized in that
each second conduit carrying gas from the cryogen space is bifurcated into two conduit branches, a first conduit branch leading to the storage space, and a second conduit branch leading to the external environment outside the dewar;
the one or more valves include a valve connected to the second conduit branch adapted to, when open, direct gas from the cryogen space to leave the dewar and, when closed, direct gas from the cryogen space to the storage space; and
a flow resistance of the first conduit branch differs from a flow resistance of the second conduit branch so that, when the valve connected to the second conduit branch is open, more gas leaving the cryogen space flows through the second branch than the first branch.

Embodiment 32. Apparatus according to embodiment 31, further characterized in that the first conduit branch includes means for adjusting gas flow resistance.

Embodiment 33. Apparatus according to embodiment 28, further characterized in that second conduits leading to the storage space have a higher flow resistance than second conduits leading to the external environment so that, when the latter conduits are open, more gas from the cryogen space flows to the external environment outside the dewar than to the storage space.

Embodiment 34. Apparatus according to embodiment 33, further characterized in that the second conduits leading to the storage space include means for adjusting gas flow resistance.

Embodiment 35. Apparatus according to embodiment 28, further characterized in that the one or more valves are located outside the dewar.

Embodiment 36. Apparatus according to embodiment 35, further characterized in that the one or more valves comprise relief valves adapted to open automatically when pressure inside the cryogen space rises.

Embodiment 37. Apparatus according to embodiments 27 or 28, further characterized in that the first conduits and the second conduits are substantially contained within a vacuum space between the inner and the outer walls. As used herein, “substantially contained” refers to 80% or more of the total volume or total length of the conduits.

Embodiment 38. Apparatus according to embodiment 37, further characterized in that the first conduits and the second conduits include insulation.

Embodiment 39. Apparatus according to embodiment 28, further characterized in that a default state of the one or more valves directs gas from the cryogen space into the storage space, and a power-on state of the one or more valves directs gas from the cryogen space to the external environment.

Embodiment 40. Apparatus according to embodiment 39, further characterized in that the one or more valves are configured to be in the power-on state during cryogen refilling.

Embodiment 41. Method for using any of the dewars of embodiments 28 to 36, 39, or 40 to reduce entry of warm, moist air into the storage space during opening of a dewar lid, the method comprising:
opening at least one of the one or more valves, and
characterized in that
the method further comprises injecting dry gas into at least one of the second conduits such that the dry gas flows into the cryogen space and then into the storage space.

Embodiment 42. Method for using the dewar of embodiment 37 to reduce entry of warm, moist air into the storage space during opening of a dewar lid, the method comprising:
opening at least one of the one or more valves, and
characterized in that
the method further comprises injecting dry gas into at least one of the second conduits such that the dry gas flows into the cryogen space and then into the storage space.

Embodiment 43. Method for using the dewar of embodiment 38 to reduce entry of warm, moist air into the storage space during opening of a dewar lid, the method comprising:
opening at least one of the one or more valves, and
characterized in that
the method further comprises injecting dry gas into at least one of the second conduits such that the dry gas flows into the cryogen space and then into the storage space.

Embodiment 44. Method for using any of the dewars of embodiments 28 to 36, 39, or 40 to reduce entry of warm, moist air into the storage space during opening of a dewar lid, characterized in that the method comprises:
injecting dry gas into at least one of the first conduits such that the dry gas bubbles through the liquid cryogen and flows from the cryogen space to the storage space.

Embodiment 45. Method for using the dewar of embodiment 37 to reduce entry of warm, moist air into the storage space during opening of a dewar lid, characterized in that the method comprises:
injecting dry gas into at least one of the first conduits such that the dry gas bubbles through the liquid cryogen and flows from the cryogen space to the storage spa.

Embodiment 46. Method for using the dewar of embodiment 38 to reduce entry of warm, moist air into the storage space during opening of a dewar lid, characterized in that the method comprises:
injecting dry gas into at least one of the first conduits such that the dry gas bubbles through the liquid cryogen and flows from the cryogen space to the storage spa.

Embodiment 47. Method for using any of the dewars of embodiments 28 to 36, 39, or 40 to accelerate cooling of the storage space, characterized in that the method comprises:
injecting dry gas into at least one of the first conduits such that the dry gas bubbles through the liquid cryogen and flows from the cryogen space to the storage space.

Embodiment 48. Method for using the dewar of embodiment 37 to accelerate cooling of the storage space, characterized in that the method comprises:
injecting dry gas into at least one of the first conduits such that the dry gas bubbles through the liquid cryogen and flows from the cryogen space to the storage space.

Embodiment 49. Method for using the dewar of embodiment 38 to accelerate cooling of the storage space, characterized in that the method comprises:
injecting dry gas into at least one of the first conduits such that the dry gas bubbles through the liquid cryogen and flows from the cryogen space to the storage space.

Embodiment 50. Method for using any of the dewars of embodiments 28 to 36, 39, or 40 to reduce temperature disturbance within the storage space during refilling of liquid cryogen, characterized in that the method comprises:
adjusting the one or more valves to direct gas to the external environment of the dewar during refilling; and
adjusting the one or more valves to direct gas to the storage space of the dewar before and after refilling.

Embodiment 51. Method for using the dewar of embodiment 37 to reduce temperature disturbance within the storage space during refilling of liquid cryogen, characterized in that the method comprises:
adjusting the one or more valves to direct gas to the external environment of the dewar during refilling; and
adjusting the one or more valves to direct gas to the storage space of the dewar before and after refilling.

Embodiment 52. Method for using the dewar of embodiment 38 to reduce temperature disturbance within the storage space during refilling of liquid cryogen, characterized in that the method comprises:
adjusting the one or more valves to direct gas to the external environment of the dewar during refilling; and
adjusting the one or more valves to direct gas to the storage space of the dewar before and after refilling.

Embodiment 53. A device for storing material at a cryogenic temperature, comprising:
a) a dewar;
b) a storage space within the dewar into which materials, or containers for storing material, may be placed such that the materials or containers can be added or removed from the dewar;
c) a cryogen space within the dewar containing liquid cryogen and cryogen gas;
d) a barrier between the storage space and cryogen space permitting no exchange of gas or liquid between them;
e) one or more conduits able to carry liquid cryogen from the external environment outside the dewar to fill the cryogen space without penetrating the storage space or releasing cryogen into the storage space;
f) one or more conduits able to carry gas from the cryogen space to the external environment outside the dewar without penetrating the storage space or releasing gas into the storage space.

Embodiment 54. A device for storing material at a cryogenic temperature, comprising:
a) a dewar;
b) a storage space within the dewar into which materials, or containers for storing material, may be placed such that the materials or containers can be added or removed from the dewar;
c) a cryogen space within the dewar containing liquid cryogen and cryogen gas;
d) a barrier between the storage space and cryogen space permitting no exchange of gas or liquid between them;
e) one or more conduits able to carry liquid cryogen from the external environment outside the dewar to fill the cryogen space without penetrating the storage space or releasing cryogen into the storage space;
f) one or more conduits able to carry gas from the cryogen space that include one or more valves able to switch between favoring sending gas from the cryogen space either to the storage space or to the external environment outside the dewar.

Embodiment 55. The device of embodiment 54 wherein for each conduit carrying gas from the cryogen space, there is a three-port valve that sends gas from the cryogen space entering the common port of the valve either to the storage space or to the external environment outside the dewar.

Embodiment 56. The device of embodiment 54 wherein conduits carrying gas from the cryogen space can be opened or closed by valves, each conduit carries gas to either the storage space or external environment outside the dewar, and the valves are synchronized so that gas from the cryogen space can be selected to flow either to the storage space or outside the dewar.

Embodiment 57. The device of embodiment 54 wherein for each conduit carrying gas from the cryogen space, there exists:
a) a bifurcation of the conduit carrying gas from the cryogen space, with one conduit branch leading to the storage space, and the other conduit branch leading to the external environment outside the dewar;
b) a valve connected to the conduit branch leading outside the dewar that when open allows gas from the cryogen space to leave the dewar, and that when closed occludes the branch leading outside the dewar, forcing gas from the cryogen space to divert to the storage space;
c) a differential flow resistance in the bifurcation branches such that when the valve of embodiment 5(b) is open, more gas leaving the cryogen space flows through the branch leading outside the dewar than the branch leading to the storage space.

Embodiment 58. The device of embodiment 54 wherein conduits carrying gas from the cryogen space lead either outside the dewar or to the storage space; conduits carrying gas outside the dewar can be opened or closed by valves; and conduits carrying gas to the storage space have a higher flow resistance than conduits carrying gas outside the dewar, so that when the latter conduits are open, more gas from the cryogen space leaves the dewar rather than entering the storage space.

Embodiment 59. The devices of embodiments 57 and 58 wherein the valves are located outside the dewar for ease of operation and maintenance.

Embodiment 60. The devices of embodiments 53-59 wherein the conduits are principally contained within the vacuum space between the dewar inner and outer walls.

Embodiment 61. The devices of embodiment 60 wherein the conduits within the vacuum space are shielded by insulation that minimizes radiative heat transfer.

Embodiment 62. The devices of embodiments 54-61 wherein the default, power-off state of the valves results in gas from the cryogen space flowing into the storage space instead of directly leaving the dewar, and actuating or energizing the valves results in most or all gas from the cryogen space leaving the dewar without entering the storage space.

Embodiment 63. The device of embodiment 62 wherein provision is made to actuate or energize the valves during cryogen refilling.

Embodiment 64. A method of reducing temperature disturbance within the storage space of a dewar during refilling of liquid cryogen, consisting of operating the valves of the devices of embodiments 54-63 during refilling such that most or all gas that is introduced, generated, or displaced from the cryogen space leaves the dewar without entering the storage space during refilling.

Embodiment 65. A method of reducing entry of warm, moist air into the storage space of a dewar during opening of the dewar lid consisting of opening the valves of the devices of embodiments 56 or 58 and injecting dry gas into the gas conduit outside the dewar so that the dry gas flows into the cold cryogen space and thence into the storage space.

Embodiment 66. A method of reducing entry of warm, moist air into the storage space of a dewar during opening of the dewar lid consisting injecting gas into the cryogen fill conduit of the devices of embodiments 56, 57 or 58, and opening the storage gas conduit valve(s) of the device of embodiment 56, so that the injected gas bubbles through the liquid cryogen, passes through the cryogen space, and flows into the conduits leading from the cryogen space to the storage space.

Embodiment 67. A method of accelerating cooling of the storage space of a dewar consisting injecting gas into the cryogen fill conduit of the devices of embodiments 56, 57 or 58, and opening the storage gas conduit valve(s) of the device of embodiment 56, so that the injected gas bubbles through the liquid cryogen, passes through the cryogen space, and flows into the conduits leading from the cryogen space to the storage space.

Embodiment 68. The devices of embodiment 59 wherein the valves consist solely of one or more relief valves attached to conduits carrying gas outside the dewar such that the valves open automatically when pressure inside the cryogen space rises during cryogen filling.

Embodiment 69. The devices of embodiments 57, 58, 59 or 68 wherein the conduit leading into the storage space and/or its opening within the storage space has an adjustable gas flow resistance.

Embodiment 70. A method of reducing temperature disturbance within the storage space of a dewar during refilling of liquid cryogen, consisting of operating the valves of any one of the devices of embodiments 2 through 14 during refilling such that most or all gas that is introduced, generated, or displaced from the cryogen space leaves the dewar without entering the storage space during refilling.

Embodiment 71. A method of reducing entry of warm, moist air into the storage space of a dewar during opening of the dewar lid consisting of opening the valves of any one of the devices of embodiments 2 through 14 and injecting dry gas into the gas conduit outside the dewar so that the dry gas flows into the cold cryogen space and thence into the storage space.

Embodiment 72. A method of reducing entry of warm, moist air into the storage space of a dewar during opening of the dewar lid consisting injecting gas into the cryogen fill conduit of any one of the devices of embodiments 2 through 14, and opening the storage gas conduit valve(s) of any one of the devices of embodiments 2 through 14, so that the injected gas bubbles through the liquid cryogen, passes through the cryogen space, and flows into the conduits leading from the cryogen space to the storage space.

Embodiment 73. A method of accelerating cooling of the storage space of a dewar consisting injecting gas into the cryogen fill conduit of any one of the devices of embodiments 2 through 14, and opening the storage gas conduit valve(s) of the device of any one of the devices of embodiments 2 through 14, so that the injected gas bubbles through the liquid cryogen, passes through the cryogen space, and flows into the conduits leading from the cryogen space to the storage space.

### BRIEF DESCRIPTION OF THE DRAWINGS

The drawings show schematic connections between spaces, conduits, and valves. The drawings are not to scale.

Whenever drawings show symmetrical duplicates of conduits and valves on the left and right sides of a drawing, it is to be understood that the conduits and valves shown can exist either singularly or as a plurality with no symmetry or number requirement for the device to operate as disclosed.

The drawings generally use liquid nitrogen as an example, but the liquid shown could be any suitable cryogen.

FIG. 1 shows a dewar 10 for storing materials in a cryogenic environment.

FIG. 2 shows a dewar 10A having increased temperature stability during cryogen refilling, according to some embodiments of the present disclosure.

FIG. 3 shows another dewar 10B having increased temperature stability during cryogen refilling, according to some embodiments of the present disclosure.

FIG. 4 shows yet another dewar 10C having increased temperature stability during cryogen refilling, according to some embodiments of the present disclosure.

FIG. 5 shows a fourth dewar 10D having increased temperature stability during cryogen refilling, according to some embodiments of the present disclosure.

FIG. 6 shows a fifth dewar 10E having increased temperature stability during cryogen refilling, according to some embodiments of the present disclosure.

FIG. 7 shows a sixth dewar 10F having increased temperature stability during cryogen refilling, according to some embodiments of the present disclosure.

FIG. 8 shows a seventh dewar 10G having increased temperature stability during cryogen refilling, according to some embodiments of the present disclosure.

FIG. 9 shows an eighth dewar 10H having increased temperature stability during cryogen refilling, according to some embodiments of the present disclosure.

### DETAILED DESCRIPTION

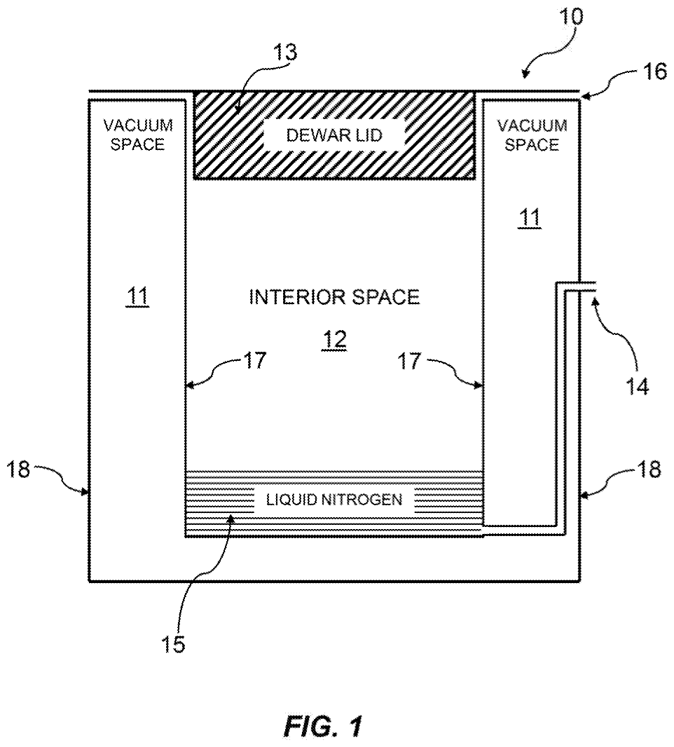

FIG. 1 shows a dewar 10 used for storage of materials in a low temperature gas environment inside the dewar. As known in the art, vacuum space 11 containing layers of reflective insulation (not shown) thermally insulates the interior space 12 of dewar 10 from the ambient temperature of the environment external to the dewar. The vacuum space 11 is contained between a cylindrical inner dewar wall 17 and cylindrical outer dewar wall 18. A removable foam lid 13 thermally insulates the top of the dewar, and provides access to the interior space 12 for addition and removal of stored materials. A cryogen conduit 14 is used to periodically refill a pool of liquid cryogen 15, such as liquid nitrogen, at the bottom of the interior space 12. Continuous evaporation of the cryogen maintains the cold temperature of the interior space. The liquid cryogen is kept at a level sufficiently low to retain a large gas-filled space above it suitable for storage of materials in a racking system (not shown). Gas produced by cryogen filling and evaporation passes from inside the dewar through the interior space 12 and then to the external environment through openings 16 of the loose-fitting dewar lid 13.

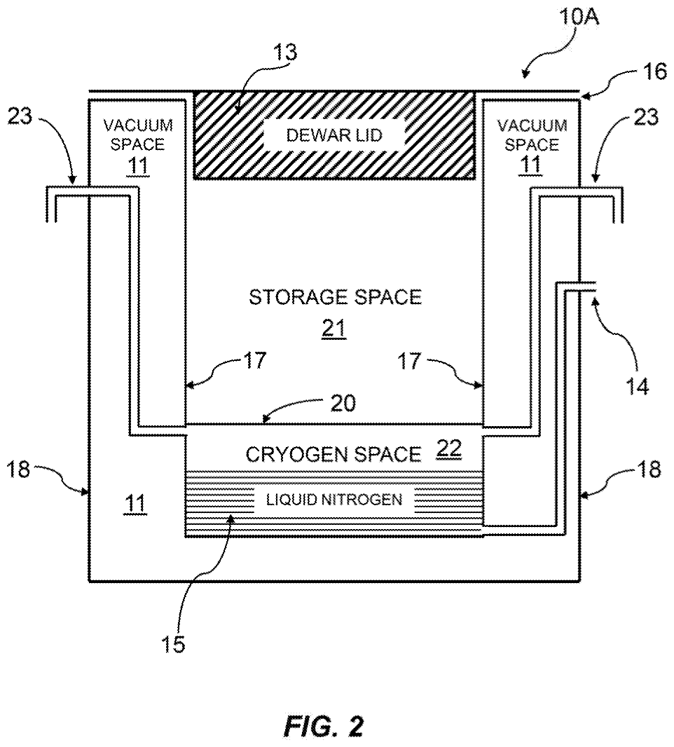

In one embodiment of the present disclosure, FIG. 2 shows a dewar 10A in which the interior space inside dewar 10A has been divided by a gas-impermeable barrier 20 into a storage space 21 containing gas, and a cryogen space 22 containing liquid cryogen and gas. As depicted in FIG. 2, the storage space 21 is bounded by dewar lid 13, inner walls 17, and barrier 20. Above the barrier 20, the storage space 21 contains no liquid nitrogen, instead having containers or materials placed for storage at a cryogenic temperature. The storage space 21 is accessible via removable dewar lid 13.

The barrier 20 separating the two spaces is substantially impenetrable by gas or liquid. For example, the barrier 20 may have a permeance of 0.1 ng/(s·m²·Pa) or less. Liquid nitrogen (or other cryogen liquid(s)) is added and replenished by a fill tube 14 passing through the vacuum space 11 and entering the cryogen space 22 near or at its bottom. The barrier 20 prevents gas produced by cryogen filling and evaporation from entering the storage space 21, instead forcing gas from the cryogen space 22 to exit the dewar through one or more gas vent conduits 23.

Accordingly, in the embodiment depicted in FIG. 2, instead of displacing gas through the entire interior space of the dewar, gas generated by boiling or evaporation of liquid nitrogen (or other liquid cryogen) in the cryogen space 22 displaces only gas in the cryogen space. This displaced gas may exit the dewar through a gas vent tube or conduit 23 connected near the top of the cryogen space 22, passing through the vacuum space 11, which leaves gas in the storage space 21 undisturbed. Advantageously, by using tube or conduit 23, the temperature of the storage space may not be disturbed by excess cold gas moving through it when the liquid nitrogen is refilled. Dewar 10A may include only one gas vent conduit 23, but in some embodiments additional conduits may be added for redundancy and/or to prevent undesired buildup of pressure in the cryogen space 22 during filling.

Generally, during operation of traditional dewars, such as the dewar of FIG. 1, the liquid nitrogen (or other liquid cryogen) in the dewar 10 contributes to keeping the dewar cold in two stages. First, the liquid nitrogen absorbs 199 kJ/kg of heat in the process of boiling/evaporating into a gas. Second, as the gaseous nitrogen rises through the interior space 12 of the dewar 10, and especially as it warms while moving between the dewar lid 13 and inner wall 17 to exit the dewar at exhaust 16, it may absorb an additional 200 kJ/kg of heat during warming to ambient temperature. Accordingly, modifications to the embodiment shown in FIG. 2 may be made to retain the latter cooling mechanism.

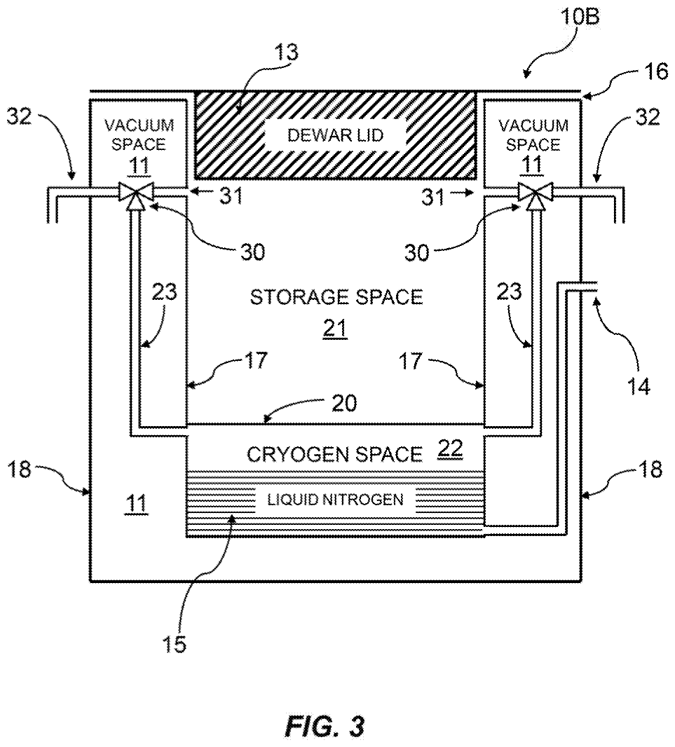

In another embodiment of the present disclosure, FIG. 3 shows another dewar 10B in which the interior space has been divided by a gas-impermeable barrier 20 into a storage space 21 containing gas, and a cryogen space 22 containing liquid cryogen and gas. In this embodiment, each gas vent conduit 23 is connected to the common port of a three-port valve 30 that diverts the gas flow from the cryogen space 22 to either an interior gas vent conduit 31 leading to the storage space 21, or an exterior gas vent conduit 32 leading to the exterior environment outside the dewar.

In the embodiment of FIG. 3, during refilling of liquid nitrogen (or other liquid cryogen), the valve 30 may send gas from the cryogen gas vent tube 23 to an exterior gas vent tube 32. Advantageously, this may avoid disturbing the temperature of the storage space 21 during filling, similar to the embodiment of FIG. 2. Moreover, in the embodiment of FIG. 3, when filling stops, the valve 30 may send gas from the cryogen gas vent tube 23 into a path 31 leading to the storage space 21 instead of the external environment. Advantageously, this may allow the cold gas from the cryogen space 22 to contribute to cooling the storage space 21 by exiting the dewar between the dewar lid 13 and interior wall 17, similar to traditional dewars. Accordingly, the embodiment of FIG. 3 (and other embodiments described below) may have the advantage of not substantially disturbing the temperature of stored material during liquid nitrogen refilling while still utilizing liquid nitrogen with increased efficiency.

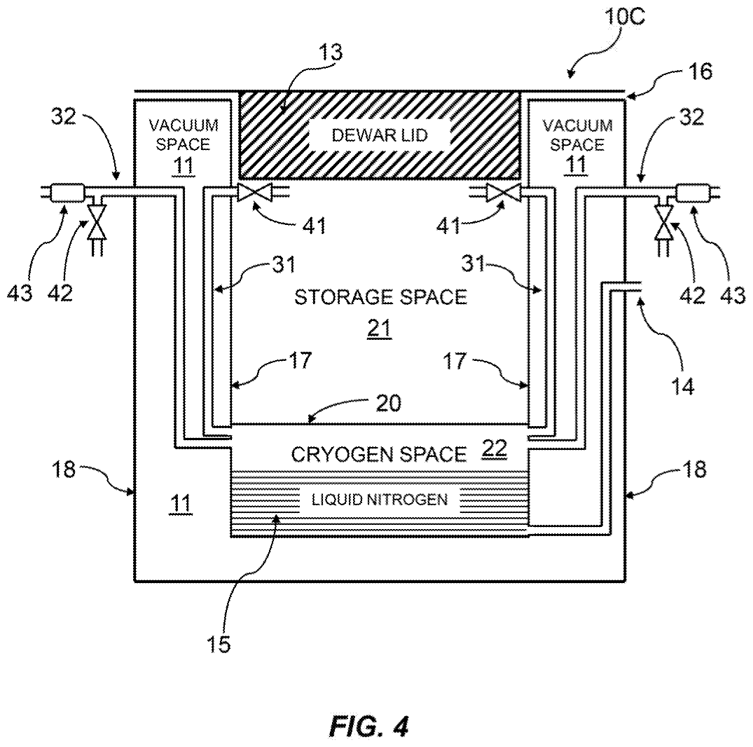

In one embodiment of the dewar, FIG. 4 shows another dewar 10C in which the interior space has been divided by a gas-impermeable barrier 20 into a storage space 21 containing gas, and a cryogen space 22 containing liquid cryogen and gas. In the embodiment of FIG. 4, there are separate interior gas vent conduits 31 and exterior gas vent conduits 32 able to vent gas from the cryogen space 22. Each interior gas vent conduit 31 may be opened or closed by an interior gas vent conduit valve 41 to release gas from the cryogen space 22 into the storage space 21. In addition, each exterior gas vent conduit 32 may be opened or closed by an exterior gas vent conduit valve 42 to release gas from the cryogen space 22 to the exterior environment outside the dewar. A pressure relief value 43 opens the exterior gas vent conduit 32 if any valve malfunction or blockage causes pressure to build in the cryogen space 22.

For ease of construction and maintenance, it may be desirable to avoid placement of valves inside the vacuum space of the dewar. Accordingly, in the embodiment of FIG. 4 there are separate types of gas vent tubes emerging from the cryogen space. There is a type of gas vent tube 32 that leads directly outside the dewar 10C, and another type of gas vent tube 31 that leads directly to the storage space 21. Gas flow paths leading to the storage space and gas flow paths leading outside the dewar are respectively controlled by separate valves 41 and 42 that may be opened or closed. During liquid nitrogen refilling, for example, valve(s) 41 may be closed, and valve(s) 42 may be opened, forcing gas from the cryogen space 22 to leave the dewar 10C without passing through the storage space 21. By way of further example, between liquid nitrogen refills, valve(s) 41 may be open, and valve(s) 42 may be closed, forcing gas from the cryogen space 22 to pass into the storage space 21. If pressure in the cryogen space 22 rises above a particular threshold, a relief valve 43 may provide a gas exit path to protect against any blockages or valve malfunctions. Advantageously, the embodiment of FIG. 4 may retain the advantages of the embodiment of FIG. 3 with a simplified construction design.

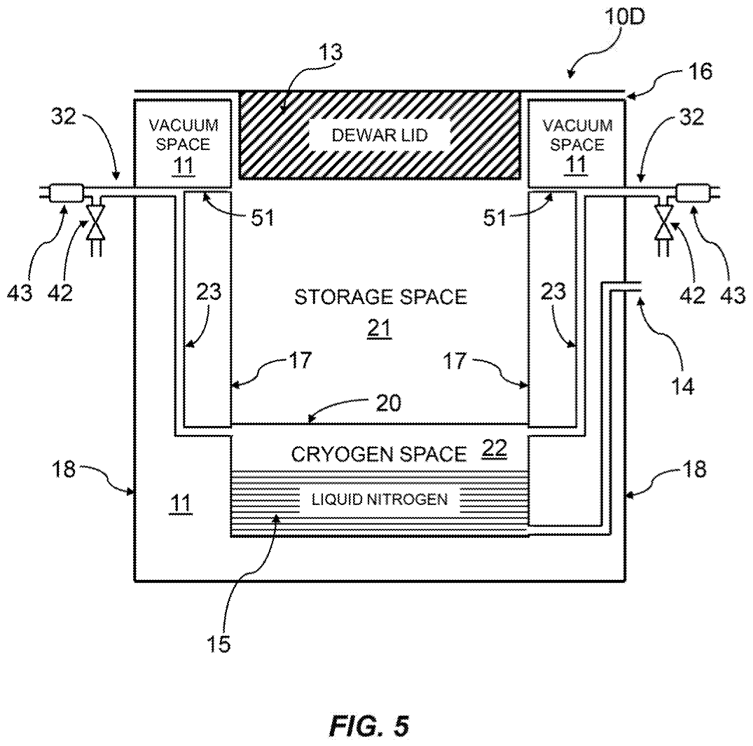

In yet another embodiment of the present disclosure, FIG. 5 shows dewar 10D in which the interior space has been divided by a gas-impermeable barrier 20 into a storage space 21 containing gas, and a cryogen space 22 containing liquid cryogen and gas. In this embodiment, each gas vent conduit 23 bifurcates into an exterior gas vent conduit 32 and a constricted interior gas vent conduit 51. The constricted interior gas vent conduit 51 may have a smaller diameter and/or smaller exit orifice than the exterior gas vent conduit 32 such that when the exterior gas vent conduit valve 42 is open, gas from the cryogen space 32 preferentially flows through the exterior gas vent conduit 32 rather than the interior gas vent conduit 51. When the exterior gas vent conduit valve 42 is closed, gas leaving the cryogen space 22 may flow into the storage space 21. A pressure relief value 43 may open the exterior gas vent conduit 32 if, for example, any valve malfunction or blockage causes pressure to build in the cryogen space 22.

Accordingly, in the embodiment of FIG. 5, only one type of gas vent tube 23 emerges from the cryogen space 22. Furthermore, in this embodiment, only the exterior vent tube 32 has a valve 42 that can be opened or closed. During liquid nitrogen (or other liquid cryogen) refilling, for example, the valve 42 may be opened. The interior vent tube 51 and/or its opening orifice may be designed so that the flow resistance of tube 51 and its opening are higher than the flow resistance of tube 32 and valve 42 when open. If valve 42 is opened during refilling, for example, gas from the cryogen space 22 may flow through the exterior vent tube 32 in preference to flowing through the interior vent tube 51. Accordingly, more gas may flow outside the dewar than into the storage space 21. On the other hand, the closure of valve 42 between refills may force gas from the cryogen space 22 into the storage space 21. Advantageously, the embodiment of FIG. 5 may minimize the number of valves (e.g., allowing for as few as one), and construction may be simplified via the placement of all valves are outside the dewar 10D.

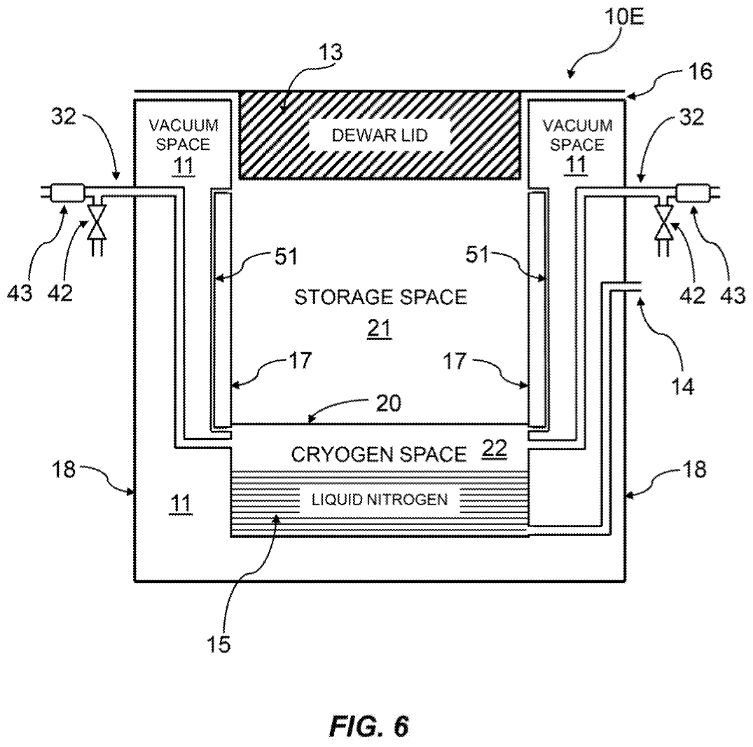

In another embodiment of the present disclosure, FIG. 6 shows dewar 10E in which the interior space has been divided by a gas-impermeable barrier 20 into a storage space 21 containing gas, and a cryogen space 22 containing liquid cryogen and gas. In the embodiment of FIG. 6, separate exterior gas vent conduits 32 and constricted interior gas vent conduits 51 emerge from the cryogen space 22. The constricted interior gas vent conduit 51 may have a smaller diameter and/or smaller exit orifice than the exterior gas vent conduit 32 such that when the exterior gas vent conduit valve 42 is open, gas from the cryogen space 32 preferentially flows through the exterior gas vent conduit 32 rather than the interior gas vent conduit 51. For example, when the exterior gas vent conduit valve 42 is closed, gas leaving the cryogen space 22 may flow through the constricted interior gas vent conduit 51 into the storage space 21. A pressure relief value 43 may open the exterior gas vent conduit 32, for example, if any valve malfunction or blockage causes pressure to build in the cryogen space 22.

Accordingly, in the embodiment of FIG. 6, tubes 51 carrying gas directly from the cryogen space 22 to the storage space 21 are designed so that they exhibit greater resistance to flow of gas from the cryogen space than exterior vent tubes 32 with valves 42 in the open state. Therefore, if valve(s) 42 are opened during refilling of liquid nitrogen (or other liquid cryogen), for example, most gas that enters or is generated in the cryogen space 22 during refilling may flow outside the dewar via vent tube(s) 32. On the other hand, when valve 42 is closed, such as when not refilling with liquid nitrogen, cold gas generated in the cryogen space 22 from evaporating liquid nitrogen may flow through vent tube(s) 51 into the storage space 21 to assist in absorbing heat that leaks into the dewar from the external environment. Advantageously, this may increase the efficiency of dewar 10E with respect to the use of liquid nitrogen (or other liquid cryogen).

Opening orifice of interior gas vent tubes 51 in any of the disclosed embodiments may be adjustable such that the flow resistance of the path through vent tube 51 and its opening may be adjusted to improve diversion of gas to the dewar exterior during refilling, while still permitting adequate venting of the cryogen space between refills when valve 42 is closed.

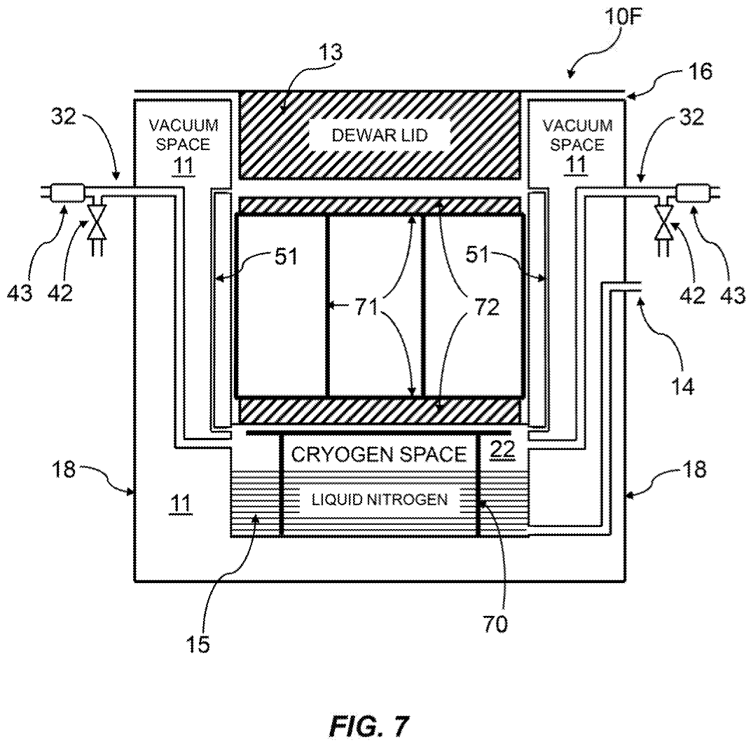

In the embodiment of FIG. 7, the storage space 21 of dewar 10F further includes a temperature chamber. For example, the temperature chamber may include vertical dividers, walls, a floor, and/or a removable ceiling made of thermally conductive metal 71 that reduces temperature gradients within the temperature chamber used for storing materials. Part of the thermally conductive metal 71 may be in contact with temperature measurement probes and heating elements to achieve precise temperature control. Layers of foam insulation 72 above and below the temperature chamber may cause the temperature chamber to reach an equilibrium temperature between the temperature of the liquid cryogen and ambient temperature outside the dewar, with the equilibrium temperature determined by the thickness and insulation efficiency of each foam layer and the dewar lid 13. Additionally, the cryogen space 22 may include a platform 70 made of thermally conductive metal that reduces temperature gradients within the cryogen space, which may help keep the cryogen space 22 at a constant temperature nearly equal to the temperature of the liquid cryogen 15 regardless of cryogen level. Advantageously, this may keep the gas-impermeable barrier 20 and/or bottom of the storage space 21 containing the temperature chamber at a constant temperature independent of the cryogen level in the cryogen space 22.

It will be understood by those skilled in the art that the embodiments of the present disclosure for minimizing disturbance of the temperature of the storage space 21 during liquid nitrogen refilling may be combined with other mechanisms that reduce the temperature gradient of a storage space, and/or finely control the temperature of a storage space. For example, in some embodiments, the storage space 21 of the present disclosure might contain a thermally-conductive sleeve to reduce the vertical temperature gradient. Alternatively or concurrently, in some embodiments, the storage space 21 may include one or more temperature chambers, an example of which having two thermally-conductive vertical compartment dividers is shown in FIG. 7. The example of FIG. 7 further includes a thermally conductive platform 70 to increase the uniformity of the temperature inside the cryogen space and increase the independence of the temperature from the liquid nitrogen level.

Generally, most of the operating time of a dewar is spent in a relatively quiescent state between liquid nitrogen refills. Therefore, when solenoid valves or other electrically-controlled valves are used in embodiments, it may be preferable for the normal power-off (e.g., default) state of the valves to result in gas from the cryogen space 22 flowing into the storage space 21.

Although it is generally preferable to avoid influx of large amounts of cold gas into the storage space, sometimes it may be desired to flood the storage space, or space above a temperature chamber in the storage space, with dry, cold gas. For example, this may be desirable to accelerate cooling of a large warm mass placed into the storage space. By way of further example, it may be desirable to displace warm, moist air introduced into the storage space by opening the dewar lid. Such cold gas flow may help clear condensed fog out of the storage space to improve visibility, and maintain cold temperatures in the storage space while the dewar lid is open.

In some embodiments, cold gas may flow into the storage space 21 by pushing either liquid nitrogen or dry gaseous nitrogen (or other cryogen) into the cryogen conduit 14, and refraining from valve actuation, leaving all valves in the default state that exists between refilling. Advantageously, this may result in excess gas in the cryogen space 22 flowing into the storage space 21 at a temperature similar to the temperature of liquid nitrogen. Alternatively, cold gas at a temperature warmer than liquid nitrogen may be made to flow into the storage space 21 by pushing dry gas into the external gas vent conduit 32 of the embodiments of, for example, FIGS. 4-9 (and optionally opening valve 41). Such methods for flushing the storage space with cold gas may expel moisture and improve visibility and may be useful when the storage space 21 contains a temperature chamber to protect stored materials from changes in the temperature of surrounding gas.

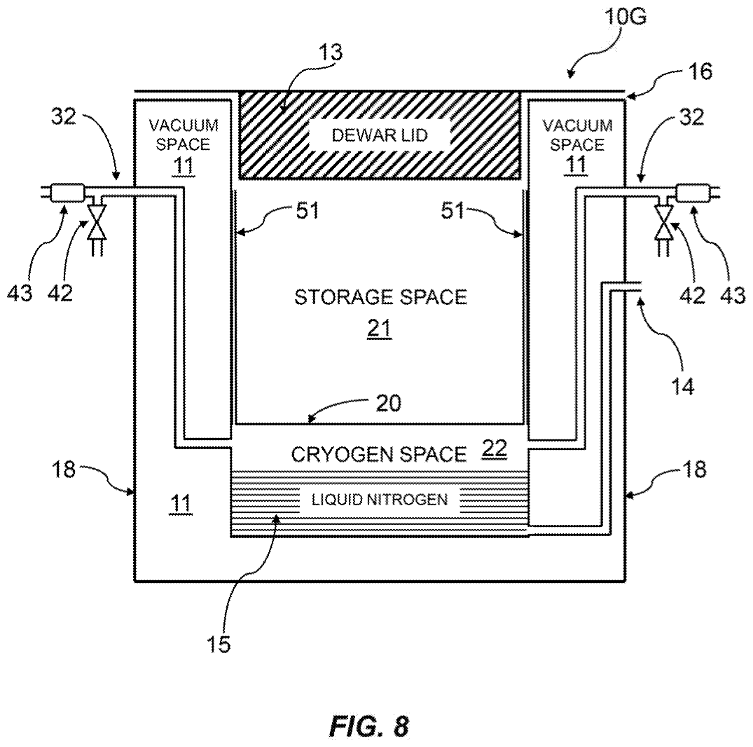

In another embodiment of the present disclosure, FIG. 8 shows a dewar 10G similar to the embodiment of FIG. 6 and with the interior gas vent conduits 51 running directly from the cryogen space 22 into the storage space 21. Each constricted interior gas vent conduit 51 may have a smaller diameter and/or smaller exit orifice than the exterior gas vent conduit 32 such that when the exterior gas vent conduit valve 42 is open, gas from the cryogen space 32 preferentially flows through the exterior gas vent conduit 32 rather than the interior gas vent conduit 51. When the exterior gas vent conduit valve 42 is closed, gas leaving the cryogen space 22 may flow through the constricted interior gas vent conduit 51 into the storage space 21. A pressure relief value 43 may open the exterior gas vent conduit 32 if, for example, any valve malfunction or blockage causes pressure to build in the cryogen space 22.

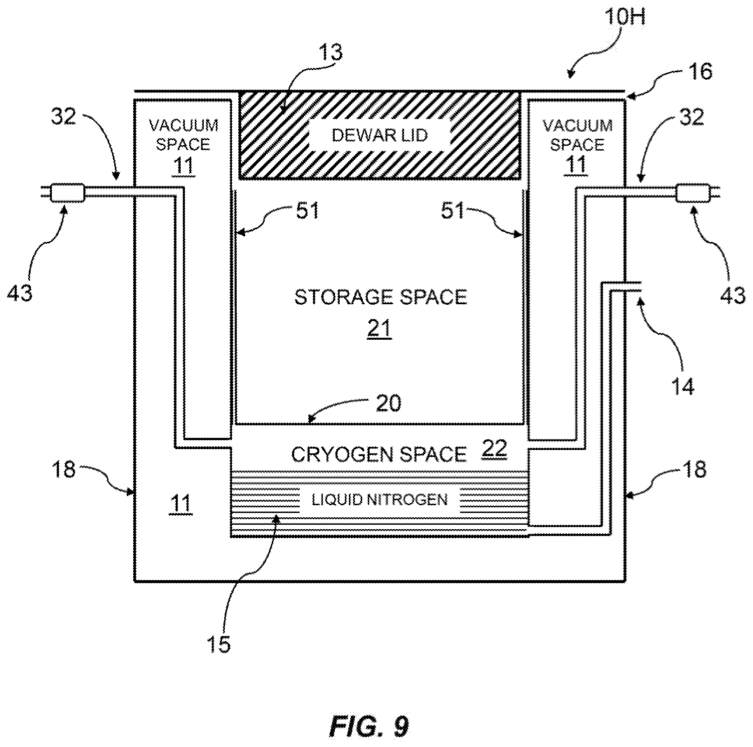

In another embodiment of the present disclosure, FIG. 9 shows a dewar 10H containing exterior gas vent conduits 32 without valve 42 of other embodiments. In this embodiment, the only valve on each exterior gas vent conduit 32 is a relief valve 43. The relief valve 43 may open automatically at a threshold pressure that occurs in the cryogen space 22 during cryogen refilling. Each constricted interior gas vent conduit 51 may have a smaller diameter and/or smaller exit orifice than the exterior gas vent conduit 32 such that when the exterior gas vent conduit relief valve 43 is open, gas from the cryogen space 22 preferentially flows through the exterior gas vent conduit 32 rather than the interior gas vent conduit 51. When the exterior gas vent conduit relief valve 43 is closed, gas leaving the cryogen space 22 may flow through the constricted interior gas vent conduit 51 into the storage space 21.

In some embodiments, no manual or electronic valve actuation may be necessary to divert gas from the cryogen space 22 to the dewar exterior during refilling with liquid nitrogen (or other liquid cryogen). For example, as depicted in FIG. 9, it is possible to equip the exterior gas vent conduit 32 solely with a pressure relief valve 43. The threshold pressure of this valve may be selected such that it only opens due to a pressure increase that occurs in the cryogen space 22 during liquid nitrogen refilling. When open, gas from the cryogen space 22 may preferentially flow through the exterior gas vent conduit 32 and relief valve 43 rather than through the constricted interior gas vent conduit 51. When liquid nitrogen is not being refilled, and pressure inside the cryogen space 22 is low, the relief valve 43 may close, and gas evaporating from liquid nitrogen in the cryogen space 22 may flow through interior conduits 51 to the storage space 21.

Although the present disclosure uses liquid nitrogen and nitrogen gas as examples, any other appropriate cryogen and its associated gas may be used.

1-56. (canceled)

57. A device for storing material at a cryogenic temperature, comprising
a dewar having inner walls and outer walls;
a storage space within the dewar configured to store materials;
a cryogen space within the dewar containing liquid cryogen and cryogen gas;
a barrier between the storage space and cryogen space permitting substantially no exchange of gas or liquid between them;
one or more first conduits configured to carry liquid cryogen from the external environment outside the dewar to fill the cryogen space without penetrating the storage space or releasing cryogen into the storage space;
one or more second conduits configured to carry gas from the cryogen space to either the storage space or the external environment outside the dewar, or both by bifurcation; and
one or more valves configured such that actuation of the valves during cryogen refilling causes gas leaving the cryogen space through the second conduits to mostly or entirely flow to the external environment outside the dewar, and such that alternative actuation of the valves after refilling causes most or all gas evolved from evaporation of cryogen in the cryogen space to flow into the storage space.

58. The device of claim 57, wherein the one or more valves are electronically actuated and configured such that application of electric power to the valves is required for gas from the cryogen space to flow to the external environment, and such that the default power-off state of the valves results in most or all gas generated within the cryogen space flowing into the storage space.

59. The device of claim 57 or 58, wherein the one of more valves include a three-port valve configured to switch between directing gas from the cryogen space entering a common port of the three-port valve to the storage space and directing gas from the cryogen space entering the common port to the external environment outside the dewar.

60. The device of claim 57 or 58, wherein the one or more valves comprise a plurality of valves, and the plurality of valves are configured to be synchronized such that gas from the cryogen space flows to either the cryogen space or the external environment without simultaneously flowing to both or neither.

61. The device of claim 57 or 58, wherein:
each second conduit carrying gas from the cryogen space is bifurcated into two conduit branches, a first conduit branch leading to the storage space, and a second conduit branch leading to the external environment outside the dewar;
wherein the one or more valves include a valve connected to the second conduit branch configured to, when open, allow gas from the cryogen space to leave the dewar and, when closed, prevent gas from the cryogen space from leaving the dewar so that the gas must flow into the storage space; and
wherein the flow resistance of the first conduit branch differs from the flow resistance of the second conduit branch such that, when the valve connected to the second conduit branch is open, more gas leaving the cryogen space flows through the second branch than the first branch.

62. The device of claim 61, wherein the first conduit branch has an adjustable gas flow resistance.

63. The device of claim 57 or 58, wherein second conduits leading to the storage space have a higher flow resistance than second conduits leading to the external environment such that, when the latter conduits are open, more gas from the cryogen space flows to the external environment outside the dewar than to the storage space.

64. The device of claim 63, wherein the second conduits leading to the storage space have an adjustable gas flow resistance.

65. The device of any one of claim 57 or 58 wherein the one or more valves are located outside the dewar.

66. The device of claim 61, wherein the one or more valves are located outside the dewar.

67. The device of claim 62, wherein the one or more valves are located outside the dewar.

68. The device of claim 63, wherein the one or more valves are located outside the dewar.

69. The device of claim 64, wherein the one or more valves are located outside the dewar.

70. A method of reducing temperature disturbance within the storage space of a dewar during refilling of liquid cryogen, consisting of operating the valves of any one of the devices of claim 57 or 58 during refilling such that most or all gas that is introduced, generated, or displaced from the cryogen space leaves the dewar without entering the storage space during refilling.

71. A method of reducing temperature disturbance within the storage space of a dewar during refilling of liquid cryogen, consisting of operating the valves of the device of claim 59 during refilling such that most or all gas that is introduced, generated, or displaced from the cryogen space leaves the dewar without entering the storage space during refilling.

72. A method of reducing temperature disturbance within the storage space of a dewar during refilling of liquid cryogen, consisting of operating the valves of the device of claim 60 during refilling such that most or all gas that is introduced, generated, or displaced from the cryogen space leaves the dewar without entering the storage space during refilling.

73. A method of reducing temperature disturbance within the storage space of a dewar during refilling of liquid cryogen, consisting of operating the valves of the device of claim 61 during refilling such that most or all gas that is introduced, generated, or displaced from the cryogen space leaves the dewar without entering the storage space during refilling.

74. A method of reducing temperature disturbance within the storage space of a dewar during refilling of liquid cryogen, consisting of operating the valves of the device of claim 62 during refilling such that most or all gas that is introduced, generated, or displaced from the cryogen space leaves the dewar without entering the storage space during refilling.

75. A method of reducing temperature disturbance within the storage space of a dewar during refilling of liquid cryogen, consisting of operating the valves of the device of claim 63 during refilling such that most or all gas that is introduced, generated, or displaced from the cryogen space leaves the dewar without entering the storage space during refilling.

76. A method of reducing temperature disturbance within the storage space of a dewar during refilling of liquid cryogen, consisting of operating the valves of the device of claim 64 during refilling such that most or all gas that is introduced, generated, or displaced from the cryogen space leaves the dewar without entering the storage space during refilling.

77. A method of reducing temperature disturbance within the storage space of a dewar during refilling of liquid cryogen, consisting of operating the valves of the device of claim 65 during refilling such that most or all gas that is introduced, generated, or displaced from the cryogen space leaves the dewar without entering the storage space during refilling.
